SEQUENCE LISTING (8 sequences)

SEQ ID NO: 1 - DNA, 35 bp, Artificial Sequence
  Description of Artificial Sequence Synthetic primer
  modified_base (21)..(30): a, c, t, g, unknown or other
gaccacacgtcgactagtgcnnnnnnnnnntctac

SEQ ID NO: 2 - DNA, 35 bp, Artificial Sequence
  Description of Artificial Sequence Synthetic primer
  modified_base (21)..(30): a, c, t, g, unknown or other
gaccacacgtcgactagtgcnnnnnnnnnnacgcc

SEQ ID NO: 3 - DNA, 35 bp, Artificial Sequence
  Description of Artificial Sequence Synthetic primer
  modified_base (21)..(30): a, c, t, g, unknown or other
gaccacacgtcgactagtgcnnnnnnnnnngatac

SEQ ID NO: 4 - DNA, 20 bp, Artificial Sequence
  Description of Artificial Sequence Synthetic primer
gaccacacgtcgactagtgc

SEQ ID NO: 5 - DNA, 32 bp, Artificial Sequence
  Description of Artificial Sequence Synthetic primer
gaatatggctcataacaccccttgtattactg

SEQ ID NO: 6 - DNA, 30 bp, Artificial Sequence
  Description of Artificial Sequence Synthetic primer
cttgtgcaatgtaacatcagagattttgag

SEQ ID NO: 7 - DNA, 24 bp, Artificial Sequence
  Description of Artificial Sequence Synthetic primer
ccaactggtccacctacaacaaag

SEQ ID NO: 8 - DNA, 22 bp, Artificial Sequence
  Description of Artificial Sequence Synthetic primer
caaagctctcatcaaccgtggc

(19) United States
(12) Patent Application Publication
(10) Pub. No.: US 2022/0378051 A1
(43) Pub. Date: Dec. 1, 2022

(54) BACTERIOPHAGE COCKTAIL FOR CONTROL OF SALMONELLA AND ESCHERICHIA COLI

(71) Applicant: Regents of the University of Minnesota, Minneapolis, MN (US)

(72) Inventors: Steven Douglas Bowden, Minneapolis, MN (US); Eleanore Grace Hansen, Minneapolis, MN (US); John Arthur McFarlane, Minneapolis, MN (US); Jacob Daniel Vitt, Minneapolis, MN (US)

(21) Appl. No.: 17/719,084

(22) Filed: Apr. 12, 2022

Related U.S. Application Data
(60) Provisional application No. 63/173,788, filed on Apr. 12, 2021.

(51) Int. Cl. A01N 63/40; A01P 1/00; A23B 4/20; A23L 3/3463

(52) U.S. Cl. CPC A01N 63/40; A01P 1/00; A23B 4/20; A23L 3/3463; A23V 2002/00

(57) ABSTRACT

The invention provides combinations of bacteriophages for use in reducing and preventing growth of Salmonella enterica and Escherichia coli.

### CROSS-REFERENCE TO RELATED APPLICATION(S)

This application claims priority to U.S. Provisional Application No. 63/173,788, which was filed on Apr. 12, 2021. The entire content of the application(s) referenced above is(are) hereby incorporated by reference herein.

### SEQUENCE LISTING

The instant application contains a Sequence Listing which has been submitted electronically in ASCII format and is hereby incorporated by reference in its entirety. Said ASCII copy, created on May 26, 2022, is named 09531 536US1 SL.txt and is 2,381 bytes in size.

### BACKGROUND

Salmonella and Shiga toxigenic Escherichia coli pose a significant risk to public health, with tens of thousands of cases occurring each year. Food is the primary vehicle for Salmonella and Shiga toxigenic E. coli outbreaks, and several diverse foods are frequently attributed to outbreaks. Traditional methods of pathogen control in the food industry are often indiscriminate, killing microbes that may be beneficial alongside the pathogens. In addition, these methods can alter the organoleptic properties of foods and may not be usable for raw and ready-to-eat foods such as raw poultry or fresh produce. Use of chemical antimicrobials is also growing out of favor in some settings as concerns rise over antimicrobial resistance in foodborne pathogens. Because Salmonella, and E. coli O157:H7, are foodborne pathogens of concern to several sectors of the food industry. Means for controlling these pathogens are needed.

### SUMMARY OF CERTAIN EMBODIMENTS OF THE INVENTION

Bacteriophages are promising new biocontrol agents for pathogens in the food system, e.g., as an alternative or supplement to traditional processing techniques and chemical antimicrobials. The specificity, safety, and preservation of the organoleptic properties of foods make phages especially ideal for raw and ready-to-eat foods. As described herein, local Minnesota wastewater samples were used to isolate 27 unique bacteriophages capable of infecting Salmonella. The host ranges were assessed for the phages on 19 strains of Salmonella, and a phage cocktail was produced based on their complimentary host ranges. The cocktail was also effective against four STEC serotypes. The receptors for the phages were determined to be BtuB, a porin that aids in vitamin B12 import into the host cell. In a chicken model, the cocktail reduced Salmonella levels by approximately 0.7 logs, indicating nearly 80% of Salmonella cells applied to the chicken were lysed. The addition of a nonionic surfactant, Tween 80 to the chicken surface prior to phage application reduced the efficacy of the cocktail. This may be important to consider when applying phage cocktails to a food product formulated with Tween 80. To summarize, selective combinations of the phages identified show promise as a biocontrol agent for both Salmonella and STEC in food applications.

Accordingly, certain embodiments of the present invention provide bacteriophages (e.g., isolated bacteriophages) that infect and lyse Salmonella enterica and/or Escherichia coli serotype O157:H7 and combinations thereof.

Certain embodiments provide a composition comprising a combination of at least two bacteriophages selected from bacteriophages EH1, EH2, EH3, EH4, EH5, EH6, EH7, EH8, EH9, EH10, EH11, EH12, EH13, EH14, EH15, EH16, EH17, EH18, EH19, EH2O, EH21, EH22, EH23, EH24, EH25, EH26 and EH27.

In certain embodiments, the composition comprises at least three bacteriophages selected from bacteriophages EH1, EH2, EH3, EH4, EH5, EH6, EH7, EH8, EH9, EH10, EH11, EH12, EH13, EH14, EH15, EH16, EH17, EH18, EH19, EH2O, EH21, EH22, EH23, EH24, EH25, EH26 and EH27.

In certain embodiments, the bacteriophages are selected from EH1, EH2, EH3, EH4, EH5 and EH6.

In certain embodiments, the composition comprises bacteriophage EH1.

In certain embodiments, the composition comprises bacteriophage EH2.

In certain embodiments, the composition comprises bacteriophage EH3.

In certain embodiments, the composition comprises bacteriophage EH4.

In certain embodiments, the composition comprises bacteriophage EH5.

In certain embodiments, the composition comprises bacteriophage EH6.

In certain embodiments, the composition comprises bacteriophages EH5 and EH6.

In certain embodiments, the composition comprises bacteriophages EH2 or EH3 and EH5 and EH6.

In certain embodiments, the composition comprises bacteriophages EH2, EH5 and EH6.

In certain embodiments, the composition comprises EH3, EH5 and EH6.

Certain embodiments provide a method for reducing the presence of Salmonella enterica and/or Escherichia coli comprising contacting the Salmonella enterica and/or Escherichia coli with an effective amount of at least one bacteriophage or a composition that comprises at least one bacteriophage described herein.

In certain embodiments, the method reduced the presence of Salmonella enterica.

In certain embodiments, the method reduced the presence of Escherichia coli.

In certain embodiments, the method reduces the presence of Salmonella enterica and Escherichia coli

In certain embodiments, the Escherichia coli is Escherichia coli O157:H7.

In certain embodiments, the Salmonella enterica and/or Escherichia coli is on a surface.

In certain embodiments, the surface is the surface of chicken, vegetable, fruit, egg, turkey or beef.

In certain embodiments, the surface is a food-contact surface.

In certain embodiments, the method does not comprise contacting the surface with a surfactant.

### DETAILED DESCRIPTION

Certain embodiments provide a composition that comprises a bacteriophage (e.g., an isolated bacteriophage) as described herein. Certain embodiments provide a composition that comprises a combination of bacteriophages as described herein.

In certain embodiments, the bacteriophage or combination of bacteriophages is useful in reducing the presence of Salmonella enterica and Escherichia coli. In certain embodiments, the Escherichia coli is Escherichia coli serotype O157:H7.

Certain embodiments provide an isolated bacteriophage as described herein.

A method for the prevention of foodborne illness caused by Salmonella enterica or Escherichia coli comprising, preparing a food item or surface used in food processing by contacting the food item or surface with a phage or combination of phages described herein.

In certain embodiments, provided herein are each of the bacteriophages EH1, EH2, EH3, EH4, EH5, EH6, EH7, EH8, EH9, EH10, EH11, EH12, EH13, EH14, EH15, EH16, EH17, EH18, EH19, EH2O, EH21, EH22, EH23, EH24, EH25, EH26 and EH27. Each of these bacteriophages, alone or in combination (e.g., a 2-way, 3-way, 4-way, 5-way or 6-way combination), may be isolated and/or purified. Each of these bacteriophages, alone or in combination, which may be isolated and/or purified, can be included in a composition. The table below at each intersection provides for certain 2-way combinations, which include EH1-EH2, EH1-EH3, EH1-EH4, EH1-EH5, EH1-EH6, EH2-EH3, EH2-EH4, EH2-EH5, EH2-EH6, EH3-EH4, EH3-EH5, EH3-EH6, EH4-EH5, EH4-EH6 and EH5-EH6.

| | EH1 | EH2 | EH3 | EH4 | EH5 | EH6 |
|---|---|---|---|---|---|---|
| EH1 | | X | X | X | X | X |
| EH2 | X | | X | X | X | X |
| EH3 | X | X | | X | X | X |
| EH4 | X | X | X | | X | X |
| EH5 | X | X | X | X | | X |
| EH6 | X | X | X | X | X | |

The bacteriophages, either alone or in combination, in certain embodiments are effective to reduce the presence (e.g., kill or lyse) Salmonella enterica and/or Escherichia coli. In certain embodiments, the bacteriophages reduce the presence by at least 50%, 55%, 60%, 65%, 70%, 75%, 80%, 85%, 90%, 91%, 92%, 93%, 94%, 95%, 96%, 97%, 98%, 99%, 99.5 or 99.9%. An effective amount of the bacteriophage(s) is an amount effective to reduce the presence (e.g., kill or lyse) Salmonella enterica and/or Escherichia coli. Often in food safety, several approaches for reducing the presence of Salmonella enterica and/or Escherichia coli are used in concert or sequentially, called hurdle technology. In certain embodiments the phages may be used with other food safety procedures in a hurdle technology type of approach.

Peracetic acid is commonly used in the food industry to control Salmonella. Phages may in certain embodiments be used in combination with these types of commonly used antimicrobials. Phages may also be used in combination with physical methods such as cold plasma.

In certain embodiments, a titer of at least 10⁷-10¹⁰ plaque forming units/mL is provided in the composition.

In certain embodiments, the composition is in liquid form, optionally comprising a food-safe buffer solution, e.g., saline, e.g., phosphate buffered saline.

In certain embodiments, the composition that comprises the phage(s) is a watery solution, which phages can be produced and purified separately and mixed, e.g., in equal concentrations. An example of a commercial product has a minimal titer of 2×10¹¹ pfu/mL. This product may be diluted, e.g., with water at application sites by a factor 10-100 to provide application rates at a maximum of 1×10⁹ pfu/gram of treated food.

Bacteriophages, or phages, are viruses that infect bacteria. They are highly host specific, safe to consume, relatively inexpensive, and do not alter the organoleptic properties of food, making them ideal as a biocontrol agent in a variety of food applications. Using several phages combined in a cocktail can increase their success in killing pathogens and lower the chance of resistance to the phages developing. Phages are the most abundant biological entity on the planet, and most remain undiscovered. A few commercial phage cocktails exist that may be used in the food industry but identifying novel cocktails of unique phages increases the diversity of the tools available to handle troublesome pathogens that arise.

As described herein, phages were isolated from local Minnesota wastewater samples. The newly isolated phages were tested for their ability to lyse and kill several serotypes of Salmonella and a few serotypes of Shiga-toxin producing E. coli. Six promising phages were picked for inclusion in cocktails. These putative cocktails were assessed for ability to reduce Salmonella levels in a raw chicken breast model. The cocktails show promise as a tool to manage both Salmonella and Shiga-toxin producing E. coli in food and food processing environments.

Salmonella is a Gram-negative, rod-shaped bacteria belonging to the Enterobacteriaceae family and is made up of two species: Salmonella bongori and Salmonella enterica. Salmonella enterica is consists of six subspecies: arizonae (IIIa), diarizonae (IIIb), houtenae (IV), salamae (II), indica (VI), and enterica (I). Salmonella enterica subsp. enterica, hereafter referred to generally as Salmonella is well-known for being the causative agent of foodborne salmonellosis. Salmonella is categorized into subgroups known as serotypes, which are characterized by differences in the antigenic structures: lipopolysaccharide (LPS), flagella, and capsular polysaccharide for a few serotypes—such as Salmonella Typhi. Over 2500 serotypes of Salmonella are recognized to date. However, only a few of these serotypes are frequently associated with human disease.

Salmonellosis is characterized as gastroenteritis with accompanying symptoms of diarrhea, abdominal pain and cramping, nausea, vomiting and headaches. Symptoms of salmonellosis frequently manifest in a range from six hours to twelve days after infection. The infections are generally self-limiting, with most symptoms subsiding in ten days or less. In severe cases, invasive Salmonella infections can occur, often manifesting as meningitis, bacteremia, osteomyelitis, or septic arthritis. Those most commonly impacted by invasive infections are children under the age of five, the elderly, and the immunocompromised. While most common symptoms of Salmonella subside on their own, some will continue to have long-lasting effects such as reactive arthritis, which can remain for months to years after infection.

In the United States alone, Salmonella causes approximately 1.35 million illnesses, 26,500 hospitalizations, and 420 deaths each year. The primary vehicle for Salmonella outbreaks is contaminated food, and the prevalence of Salmonella varies with geography and commodity. In the United States, the top five serotypes of Salmonella reported between 1996 and 2011 were Typhimurium, Enteritidis, Newport, Heidelberg, and Javiana. In addition, overall rates of Salmonella infections in the United States has remained relatively constant, despite incidence rates between serotypes varying. Salmonella outbreaks are costly; they result in an economic burden of approximately $3.7 billion in medical costs annually in the United States. This does not include the costs to the food industry from foodborne Salmonella. Food safety incidents cause an estimated $7 billion loss in the U.S. economy each year. In one such incident, a Salmonella outbreak traced to peanut butter in 2007 resulted in an economic loss of $133 million. A 2009 outbreak associated with tomatoes cost the industry $250 million.

Most Salmonella outbreaks in the U.S. are attributed to foods. While many major foodborne pathogens are primarily associated with one or two food commodities, Salmonella is uniquely associated with a wider range. Approximately 75% of Salmonella outbreaks can be attributed to the following seven food commodities: chicken, seeded vegetables, pork, fruits, other produce, eggs, and turkey. Salmonella serotypes producing outbreaks vary with food commodity. From 1998 to 2008, most egg-associated Salmonella outbreaks were caused by serotypes Enteritidis and Heidelberg. For chicken, turkey, pork, and beef, the most attributed serotypes were Typhimurium, Enteritidis, Infantis, Newport, and Heidelberg. For leafy vegetables, the most commonly attributed serotypes were Newport and Javiana, while vine-stalk vegetables were primarily associated with Newport, Braenderup, Enteritidis, Javiana, and Typhimurium. This variation is assumed to be a result of the different reservoirs each serotype typically resides in. Serotype-food associations are important to help hypothesize and identify sources of outbreaks and contamination. As with overall Salmonella illnesses, the rate of Salmonella infections attributed to food sources did not change between 2016 and 2019, despite variations in incidence of each serotype. Foodborne Salmonella remains a significant food safety concern to be addressed.

Escherichia coli are Gram-negative, rod-shaped bacteria belonging to the Enterobacteriaceae family. Most E. coli are harmless and are some of the organisms that make up the human gut microflora. However, Shiga toxin-producing E. coli (STEC) are strains of E. coli that have acquired genes for producing Shiga toxin. Like Salmonella, E. coli is classified into serotypes based on its antigens, O, H, and K. The O antigen is LPS, the H antigen is flagella, and the K antigen consists of capsular polysaccharides. STEC serotype O157:H7 is most commonly recognized, but over 200 serotypes of E. coli can produce Shiga toxin. Aside from O157:H7, six other serotypes make up over 75% of STEC infections in the United States: O26, O111, O1O3, O121, O45, and O145.

STEC is estimated to cause over 265,000 illnesses, 3,600 hospitalizations, and 30 deaths each year in the United States. STEC is primarily spread through contaminated food or water, contact with an infected person or animal host. STEC infections frequently involve symptoms of diarrhea (which may be bloody), cramps, and vomiting. Symptoms can develop anywhere between one to ten days after exposure to STEC, but most commonly develop in three to four days. Approximately 5-10% of those with a STEC infection will develop Hemolytic Uremic Syndrome (HUS), which may result in renal failure and death. Those most susceptible to STEC are children under the age of five, the immunocompromised, and the elderly. Importantly, the infectious dose is very low, often even fewer than 10 cells. From 1996 to 2016, overall rates of STEC infections have increased, with non-O157:H7 STEC driving the increase as O157:H7 rates have decreased since the peak in 2000. As with Salmonella, the cost of STEC outbreaks from a food source are costly to the food industry is large as well. One outbreak of E. coli O157:H7 in spinach cost the industry $350 million in 2006.

Animals are the most common source of STEC transmission to humans and into the food system. For STEC, row vegetables are the most common vehicle for foodborne outbreaks followed by beef. Cattle serve as important reservoirs for STEC, so the processing of beef or contamination of vegetable fields likely explain the attribution of STEC to beef and row vegetables. With STEC rates rising and low infectious dose, reducing STEC transmission through common food sources such as fresh produce and beef is a necessary public health measure.

Pathogen control in foods is executed by a variety of measures, including irradiation, pasteurization, high pressure processing, cold atmospheric plasma, retort, freezing or chilling, pulsed electric field, and chemical antimicrobials. In fresh fruits and vegetables, pathogens can be internalized, so treatments including chlorine dioxide, electrolyzed water, UV light, cold atmospheric plasma, hydrogen peroxide, organic acids, acidified sodium chlorite, or high oxygen atmosphere with irradiation have shown promise in reducing pathogens both on the surface and internally. In addition to previously listed methods, hydrostatic pressure processing, active packaging, and natural antimicrobials have been employed in meat products. During slaughter, reducing pathogen levels on the carcasses is attempted using steam, water, and chemical antimicrobial solutions, and carcasses may be decontaminated by these methods prior to further processing. Despite numerous approaches for controlling pathogens, foodborne illness remains a significant concern in the United States. Additionally, each method has incompatibilities with certain food products, and several criticisms over these methods.

Several of the above methods utilize thermal means to reduce pathogens such as Salmonella, which is not always effective or compatible with preventing foodborne illness in certain products. Chilling and freezing prevent Salmonella growth, but do not kill the cells already contaminating the product. Thermal methods involving heat, such as pasteurization and retort, alter the organoleptic properties of the foods and may result in nutrient degradation. Physical means such as high pressure processing, irradiation, and drying also alter the organoleptic properties of foods. Irradiation in particular is unpopular with many consumers and known to accelerate lipid peroxidation. The presence of the radura label on foods causes mixed consumer reactions, making it an unpopular labeling requirement for industry. Natural antimicrobials such as rosemary extract or garlic extract have proven effective in poultry applications and are clean label and GRAS, but they may impart off-flavors and odors that may not be acceptable to consumers. Chemical antimicrobials and sanitizers are criticized for being harmful to the environment, becoming increasingly unpopular with consumers, and over concerns about resistant pathogens emerging. A similarity between these methods is that they are indiscriminate, i.e., they do not kill only organisms of interest, and they interfere with the natural microflora of foods. Additionally, Salmonella is associated with meat, poultry, and fresh fruits and vegetables. Frequently these items are handled and/or consumed raw by consumers, and physical or thermal processing methods for eliminating Salmonella are not employed.

Bacteriophages (phages) are viruses that infect bacteria. There are over 10³¹ phage virions on Earth, making phages the most abundant entities on the planet. The majority of phages remain undiscovered. Caudovirales phages are characterized by a polyhedral protein-based capsid, containing their double-stranded DNA, attached to a proteinaceous tail. The structures that a phage uses to interact with the host extend from the tail. Currently, five families make up Caudovirales, Myoviridae, Herelleviridae, Ackermannviridae, Siphoviridae and Podoviridae. Phages in this order are classified into their families based on tail shape, length, and contractility, as well as their adsorption structures. Myoviridae and Herelleviridae share similar morphologies and are characterized by a polyhedral head, a long, inflexible, contractile tail with a protein sheath and tail fibers at the base of the tail. Ackermannviridae have head and tail structure similar to Myoviridae and Herelleviridae but have a unique and complex adsorption structure at the base of tail in place of the tail fibers. Siphoviridae have a polyhedral head, and a long, flexible, non-contractile tail without a sheath, along with tail fibers around the base of the tail. Podoviridae are defined by a polyhedral head, a short, non-contractile tail, and tail fibers at the base.

Phages typically undergo one of two lifecycles, the lytic cycle or the lysogenic cycle, though other lifecycles, such as a pseudolysogenic lifecycle, have been identified. In both the lytic and lysogenic cycles, the phage adsorbs to its host receptor. Following this, an irreversible binding step occurs, and the phage will inject its DNA into the host cell. In the lytic cycle, the phage hijacks the host's replication machinery, utilizing it to produce progeny phages. The cycle ends with lysis and death of the host cell and release of progeny phage into the environment. These phages may then adsorb to a nearby host and begin the lytic cycle again. In contrast to the lytic cycle, the DNA of a phage undergoing the lysogenic cycle will be integrated into the host cell genome, where it will remain for an indeterminate amount of time. The integrated phage, known as a prophage, can later undergo the lytic cycle. Virulent phages are strictly lytic and cannot enter the lysogenic cycle, whereas temperate phages can enter either cycle, though they more commonly participate in the lytic cycle. During the lytic cycle, phages may mistakenly incorporate host DNA into a capsid. Such phages are known as transducing phages. When these phages bind to another host, they will inject DNA from the previous host into the cell. The new host cell may integrate this DNA into its genome. This process is known as generalized transduction, which can be performed by either temperate or lytic phages. In specialized transduction, genes nearby the phage genome, which has been incorporated to the host genome, may be mistakenly excised with the phage genome as it separates from the host genome. The improperly excised host DNA is then mistakenly incorporated into a capsid. The specialized transduction process can occur frequently with temperate phages, sometimes transferring DNA containing virulence factors or antimicrobial resistance factors from one host into another host, which may integrate that DNA into its genome. In lysogenic conversion, a phage with a genome containing a gene from a different host undergoes the lysogenic cycle, and the phage genome (containing a gene previously found in another host) is incorporated into the new host. Perhaps the most notorious example of this is the lysogenic conversion of non-pathogenic E. coli to Shiga-toxin producing E. coli by a temperate phage carrying genes encoding for Shiga-toxin production. Concerns over lysogenic conversion by temperate phages has led to calls for phages being used in the food and agriculture sectors to be strictly lytic.

Phages are highly host specific. A phage that is effective in infecting one serotype of Salmonella may not infect another serotype of Salmonella. Sometimes a phage may even successfully infect one strain of Salmonella but not another strain of the same serotype. Some phages have been discovered that infect some serotypes of both Salmonella and E. coli. The host range of a phage is determined by a variety of factors, including the receptor it recognizes, host defense mechanisms, and the phage's ability to evade host defense mechanisms, among others. Bacteria can evade infection through a variety of mechanisms, both extracellular and intracellular. The cell can sterically hinder the phage's ability to reach the receptor on the surface, induce capsular changes that hinder the phage, or use outer membrane vesicles as decoys for the phage to adsorb to. Host cells can attempt to block phage DNA injection into the cell. Once phage DNA enters the cell, additional defense mechanisms may be engaged to prevent replication and lysis, such as restriction modification systems that damage phage DNA, CRISPR systems, abortive infection systems, BREX, and DISARM. Host cells may also suppress production of endolysins, which are enzymes used to lyse the cells to free the progeny phage. In addition to the many known phage defense system, it is very likely that many yet-uncharacterized systems exist for host cells to evade phage infection.

Despite the numerous anti-phage defenses employed, some phages have mechanisms to evade these defenses. For example, phages may be able to produce endonuclease enzyme inhibitors to block restriction modification systems from destroying its DNA. Bacteria must also maneuver the balance between the cost of carrying defense systems in its genome and the benefit of evading phage with that system. Moreover, any changes made for the purpose of evading one phage could instead make the host susceptible to another phage.

Mutations in host receptors are among the most common method of evading phages. Adsorption is the first step in phage infection, and phages must be able to access and adsorb to a specific receptor on the host. Nearly any structure on the surface of the host cell can serve as a receptor, including antigens such as LPS and the flagella. However, modifications in surface structures could decrease host fitness, such as through loss of motility in an altered flagellar structure or loss of virulence.

Host receptors are major determinants in phage host ranges. Even a small change in a gene encoding a phage's receptor binding protein can alter the host range of the phage. Despite the importance of receptors for phage efficacy, they are often uncharacterized. Common receptors for Salmonella phages for those that have been assessed are LPS, flagella, and porins such as OmpC and BtuB. Some phages can recognize more than one receptor, such as phage SP6 which has two types of receptor binding proteins to increase its host range. Optimal phages would target receptors that are virulence factors so that phage-resistant mutants may have been forced to reduce their virulence in the process of becoming resistant. Overall, understanding phage receptors and other determinants of phage host ranges allows for a targeted approach to controlling specific Salmonella serotypes and strains that are proving problematic in the food industry.

Salmonella phage use has been proposed for controlling Salmonella at nearly every point along the production process, from pre-harvest (in both fresh produce and in livestock) to finished product packaging and processing environment sanitation. The host specificity of phages mean that non-target organisms will not be affected, which is especially important in fermentation processes. Because phages occur naturally in foods, they will not alter the normal microflora of foods. Phages are also abundant in the human gut. This, combined with the specificity of phages, indicates that they will not interfere with the gut microbiome when consumed. Furthermore, ingestion studies of phages have indicated that they are safe for consumption, with no signs of phages causing deleterious effects to those who consumed them. Phages are relatively inexpensive to produce: they are propagated in large cultures of their host, and the major cost of purifying phages away from any hazardous components of the host is decreasing. Because phages are so ubiquitous, they are considered natural and may be utilized in organic products, which have grown greatly in popularity in recent years. Consumer acceptance studies have shown that consumers would be willing to pay more for phage-treated produce per pound when informed about the ability of phages to increase food safety. Lastly, analysis of phage-treated foods indicated that the organoleptic properties are not affected by phage application. Phages have many beneficial components that make them an optimal biocontrol strategy in the food industry that are likely to be accepted by consumers due to their safety, natural presence, and the preservation of organoleptic properties of foods. Additionally, for industry phages are relatively inexpensive and unlikely to impact off-target organisms. These qualities appear to make phages an optimal solution to food safety problems from both the industry and consumer standpoint. However, bacteriophage biocontrol strategies are not without criticism.

The food industry has mixed opinions over utilizing phage as a primary biocontrol strategy, especially because some phages pose threats to fermentations. In addition, phages oftentimes can survive a wider range of conditions and sanitation treatments than their hosts and can remain in the processing environment, causing concern over false positive results during pathogen testing. Perhaps the most significant concern is over pathogens developing resistance to phages. This is inevitable due to evolutionary pressures and constant co-evolution of phages and their hosts. However, phage resistance is considered easier to overcome than small molecule antimicrobial resistance. Phages are often utilized in foods that are kept at refrigerated temperatures where many pathogens will not grow. This means that phage replication will not occur during storage, so resistance should not arise in any significant capacity. At least one study indicated that presence of resistant cells did not hinder the phage efficacy in their food challenge model. Still, to avoid resistance, a cocktail of phages with different receptors may be used for biocontrol of pathogens in foods.

In addition to the commercially available cocktails, various research groups have assessed the efficacy of novel Salmonella phage cocktails on a variety of foods, including tomatoes, lettuce, apples, melons, raw and cooked poultry, fruit juices, eggs, ground meat, and cheese. Notably, results from each study were variable, with log reductions in Salmonella ranging from 0.4 to 7 after phage addition. Storage temperature and the type of food matrix appear to play a role in how effective the phages were in reducing Salmonella levels. Various other factors including pH, sodium levels, exposure to UV light, interactions with other antimicrobials, surface immobilization, and interaction with food matrix components have all been reported to impact phage stability and performance. The complexity of food matrices can make predicting how well the cocktails will perform in a broad range of applications difficult. However, the reductions seen in studies to date show that phages are promising for Salmonella control.

Salmonella remains a significant public health issue in the U.S. as one of the most common agents involved in foodborne illnesses each year. Many methods of control for Salmonella are employed, but some of these are less favorable for consumers, indiscriminate killers of microbes, or not compatible with raw and RTE foods. Phages have emerged as an increasingly popular alternative to control Salmonella in foods because they are selective, safe, and natural. Criticisms of phages primarily revolve around the inevitability of resistance emerging, but this may be addressed by using a phage cocktail with several phages targeting different receptors. A select few phages and phage cocktails have been assessed for their ability to control Salmonella in the food industry, with success varying by food product and storage conditions. Most phages remain undiscovered, so continuing to identify phages and develop cocktails that are effective against Salmonella will diversify the options available to prevent outbreaks.

### EXAMPLES

### Example 1. Isolation of Bacteriophages from Local Wastewater

Salmonella enterica subsp. enterica is a Gram-negative, rod-shaped bacterium. S. enterica is categorized into over 2500 groups, or serotypes, based on their antigenic structures. The O antigen is lipopolysaccharide (LPS), H antigens consist of flagella, and capsular polysaccharide makes up the Vi antigen, though this antigen is found in a select few serotypes, most notably Salmonella Typhi. Of these over 2500 serotypes, only a select number have been frequently associated with human disease. Additionally, severity of infection varies with serotype. Prevalence of Salmonella serotypes vary in different geographic regions and in different food and animal commodities.

Escherichia coli are Gram-negative, rod-shaped bacteria. Like Salmonella, E. coli is classified into serotypes based on its antigens, O, H, and K. The O antigen is LPS, the H antigen is flagella, and the K antigen consists of capsular polysaccharides. Most E. coli are harmless and compose a normal part of a healthy human gut microbiome, but pathogenic Shiga toxin-producing E. coli (STEC) have acquired genes for producing Shiga toxin. Seven serotypes cause most of the foodborne STEC infections in the United States: O157:H7, O26, O111, O1O3, O121, O45, and O145.

Every year Salmonella is implicated in approximately 1.35 million illnesses, 26,500 hospitalizations, and 420 deaths in the United States alone, with food being the primary vehicle. Symptoms of salmonellosis manifest anywhere from six hours to twelve days after infection. Gastroenteritis accompanied by diarrhea, abdominal pain and cramping, nausea, vomiting and headaches. The infections are generally self-limiting, with most symptoms subsiding in ten days or less. However, in some cases salmonellosis can result in development of bacteriemia or other invasive infection, particularly in children under five years of age, the elderly, and the immunocompromised. In other cases, salmonellosis results in long-term effects, such as reactive arthritis that can remain for month to years after infection. The large number of Salmonella infections result in an economic burden of approximately $3.7 billion annually in the United States.

STEC is estimated to cause over 265,000 illnesses, 3,600 hospitalizations, and 30 deaths each year in the United States. Symptoms can develop anywhere between one to ten days after exposure to STEC, but most commonly develop in three to four days. Around 5-10% of those with a STEC infection will develop Hemolytic Uremic Syndrome (HUS), which may result in renal failure and death. Among those most susceptible to STEC are children under the age of five, the immunocompromised, and the elderly. The annual economic burdens attributed to O157:H7 STEC and non-O157:H7 STEC are estimated at $271 million and $27 million respectively.

Salmonella is unique from other foodborne pathogens because it is attributed with a larger range of commodities than others. Approximately 75% of Salmonella outbreaks are distributed between seven categories: chicken, seeded vegetables, pork, fruits, other produce, eggs, and turkey. For STEC, row vegetables are the most common vehicle for foodborne outbreaks, followed by beef. This is likely because cows serve a reservoir for STEC, meaning that fields of row vegetables could be contaminated from nearby cattle facilities, and beef can be contaminated during slaughter.

Traditionally used methods of control for pathogens such as Salmonella and STEC in food and on food-contact surfaces include use of chemical antimicrobial agents, high pressure processing, cold atmospheric gas plasma technology, irradiation, and other physical and thermal processes. However, concerns with these methods have been raised over antimicrobial resistance, potential environmental impacts of chemical antimicrobials, alteration of organoleptic properties, and a lack of consumer acceptance of irradiated products. Moreover, many of these methods are incompatible with raw and ready-to-eat foods, including raw meat, poultry, and fresh fruits and vegetables.

Bacteriophages, or phages, are viruses that are specific to bacteria. Phages are massively abundant on Earth, with the number of phage virions estimated to exceed 10³¹. Phages are ubiquitous: they can be found in any environment capable of supporting bacterial growth.

Phages have two primary lifecycles, the lytic cycle and the lysogenic cycle. Both cycles begin with the phage particle adsorbing onto a receptor on the host's surface, irreversibly binding, and injecting their DNA into the host cell. Phages undergoing the lytic cycle then hijack the host's replication machinery to produce more phage particles. The lytic cycle ends with lysis and death of the host cell and the release of progeny phages. Phages undergoing the lysogenic cycle will incorporate their DNA into the host's genome rather than reproducing and lysing the host, though they can enter the lytic cycle at a different time. Virulent phages are strictly lytic and cannot enter the lysogenic cycle, whereas temperate phages can enter either cycle, though they more commonly participate in the lytic cycle. During the lytic cycle, phages may mistakenly incorporate host DNA into a capsid. Such phages are known as transducing phages. When these phages bind to another host, they will inject DNA from the previous host into the cell. The new host cell may integrate this DNA into its genome. This process is known as generalized transduction, which can be performed by either temperate or lytic phages. In lysogenic conversion, a phage with a genome containing a gene from a different host undergoes the lysogenic cycle, and the phage genome (containing a gene previously found in another host) is incorporated into the new host. Perhaps the most significant example of this for the food industry is the lysogenic conversion of non-pathogenic E. coli to Shiga-toxin producing E. coli by a temperate phage carrying genes encoding for Shiga-toxin production. Because of concerns over lysogenic conversion by temperate phages resulting in pathogens that are less responsive to current measures of control, phages for use in the food and agriculture sectors should be strictly lytic phages.

Interest in using phages for biocontrol of pathogens in food and agriculture has grown in recent years due to the beneficial properties of phages. Phages are generally specific for certain species of bacteria, often only infecting a certain subpopulation of that species, which allows for the preservation of desirable microbes in the food system while managing the pathogen population. Phages can be found in any environment that supports their host bacteria, meaning they are naturally found in foods. Ingestion studies of phages have indicated that they are safe for human consumption. In fact, there are commercially available phages that have received GRAS status in the United States. Yet another benefit of phages for biocontrol is that phages are not known to affect the organoleptic properties of foods. Moreover, they can be used in organic products, which are growing in popularity with consumers. One study has even indicated that consumers may be willing to pay a premium for phage-treated produce after learning about the utility and safety of phages.

While the adoption of phages for biocontrol in the food and agriculture industries shows many promising benefits, the industries have mixed opinions about utilizing phages. Frequently cited concerns include worries about phages persisting in the food processing environments and spreading between facilities, phages interfering with testing for pathogens and producing false positives, and re-growth of pathogens after phage treatment. However, the greatest source of hesitancy to adopt phages for biocontrol is the concern over phage-resistant mutants arising.

To prevent phage-resistant mutants and to increase the range of hosts that can be targeted, developing cocktails of multiple phages that recognize different host receptors or have different means of evading host defenses has been proposed. There are some Salmonella and STEC phage cocktails available on the market, and various studies have discussed novel phage cocktails able to reduce Salmonella levels in food matrices. However, there are a limited number of such phages that have been characterized and combined into cocktails for biocontrol. A greater diversity of phages is beneficial for use in cases where resistance has developed to the available phages. In this study, local wastewater was utilized to isolate novel bacteriophages. The host ranges of the phages were assessed by the phages' ability to lyse a variety of Salmonella serotypes of concern. A phage cocktail with potential for Salmonella control in food settings was developed from phages with complimentary host ranges that encompass all serotypes tested. While Salmonella biocontrol was the primary objective in this study, the cocktail was also tested for its ability to lyse the seven most common STEC serotypes because the phages also lysed a non-pathogenic E. coli strain.

Nineteen Salmonella strains, seven STEC strains, and one nonpathogenic Escherichia coli K-12 strain, from several sources (Table 2.1) were used in the enrichment, isolation, and testing of unique bacteriophages. Strains used for this study were provided by Paradigm Diagnosic Inc. (PDX), the Salmonella Genetic Stock Centre in Calgary, Alberta, Canada (SGSC), the Minnesota Department of Health (MDH), Jay Hinton at the University of Liverpool, UK, and Lidija Truncaite at Vilnius University, Lithuania. All strains Bacteria strains were cultured at 37° C. for 16-18 hours on Luria-Bertani (LB) broth or LB agar plates. Wastewater influent samples were collected from the Eagle's Point Wastewater Treatment Plant (Cottage Grove, Minn., USA) and the Metropolitan Wastewater Treatment Plant (Saint Paul, Minn., USA). The large particulate matter was removed from the wastewater samples by filtration through Whatman No. 1 filter paper. Following this, the samples were vacuum filtered using 0.22 um pore size filters (Millipore) to remove existing bacterial cells. The filtrates were stored at 4° C. until used.

TABLE 2.1
Salmonella and E. coli strains used for phage host range assessments

| Serotype | Strain | Source |
|---|---|---|
| S. Agona | ATCC 51957 | PDX |
| S. Bareilly | PDX BB3 | PDX |
| S. Enteritidis | SGSC 2475 | SGSC |
| S. Hadar | PDX CC12 | PDX |
| S. Heidelberg | PDX AC2 | PDX |
| S. Infantis | 12018008804-1 | MDH |
| S. Javiana | PDX CD 13 | PDX |
| S. Kentucky | PDX AB7 | PDX |
| S. Mississippi | PDX BD2 | PDX |
| S. Montevideo | ATCC 8387 | PDX |
| S. Muenchen | PDXBA12 | PDX |
| S. Newport | ATCC 6962 | PDX |
| S. Oranienburg | PDX AE15 | PDX |
| S. Reading | E2018018984 | MDH |
| S. Saint Paul | PDX CD7 | PDX |
| S. Thompson | PDX CB3 | PDX |
| S. Typhimurium | 4/74 | Jay Hinton |
| S. Typhimurium | LT2 SGSC 1412 | SGSC |
| S. Typhimurium | LT2 SGSC 288 (waaL mutant) | SGSC |
| E. coli O103 | CDC 06-3008 | PDX |
| E. coli O111:H8 | CDC 2010 C-3114 | PDX |
| E. coli O121 | PDX ED3 | PDX |
| E. coli O145:NM | CDC 99-3311 | PDX |
| E. coli O157:H7 | EDL933 ATCC 43895 | ATCC |
| E. coli O26:H11 | CDC 03-3014 | PDX |
| E. coli O45:H2 | CDC 00-3039 | PDX |
| E. coli K-12 | MG1655 | Lidija Truncaite |

Five milliliters of wastewater filtrate were combined with 0.1 mL of a Salmonella strain overnight culture and 45 mL of LB broth in a 250 mL conical flask. The mixture was incubated for 37° C. with shaking for 16-18 hours to enrich viable phages on this host strain. The phage enrichment was syringe filtered through a 0.22 um pore size filter.

Individual phages were isolated using the double agar overlay plaque assay. A mixture of phages was cultivated by combining 0.1 mL of phage enrichment lysates, 0.1 mL of an overnight culture of a selected Salmonella strain for phage propagation, and 4 mL of molten 0.35% w/v LB agar. This mixture was poured onto a 1.5% w/v LB agar plate and allowed to solidify. After incubation at 37° C. for 16-18 hours (FIG. 2), individual plaques were picked and streaked onto 1.5% LB w/v agar plates. Four milliliters of molten 0.35% w/v LB agar containing 0.1 mL of the propagation strain were overlayed onto the streaked plate. After solidification of the agar overlay, the plate was incubated for 37° C. for 16-18 hours. The streaking processes was repeated three to five times, until a uniform plaque morphology was achieved.

To create pure phage lysate solutions, a single isolated plaque was picked using a 1000 uL pipette tip and aspirated into 10 mL of LB broth containing 0.1 mL of the propagation strain. After incubation at 37° C. with shaking for 16-18 hours, phage lysates were syringe filtered using 0.22 um pore size filters. Phage lysates were stored at 4° C.

Phage host ranges were determined phenotypically using spot on the lawn plaque assay. Four milliliters of molten 0.35% w/v LB agar was combined with 0.1 mL of bacterial overnight culture and poured onto a 1.5% w/v LB agar plate. While the agar solidified, phage lysates were serially diluted in SM buffer (50 mM Tris-HCl pH 7.5, 100 mM NaCl, 8 mM MgSO₄). Ten microliter aliquots of serially diluted phage lysate were spotted onto the agar overlay. After the spots dried, the plates were incubated at 37° C. for 16-18 hours. Phages were assessed on their ability to form zones of lysis and/or plaques on each individual strain, demonstrating the host range of each phage. All isolated phages were tested for their ability to lyse 19 Salmonella strains representing 17 serotypes and one strain of E. coli K-12. Additionally, the phages selected for a cocktail were tested against 7 STEC strains representing 7 different serotypes.

Phenotypic Salmonella host ranges of individual phages were compared based on the results of the spot on the lawn assays. Phages with distinct host ranges that lysed a broad variety of serotypes were selected. Six phages were selected to be combined into cocktails that could act synergistically against all 17 tested Salmonella serotypes based on their complimentary host ranges.

While there are some commercial Salmonella phages available for use in the food industry, there is not much diversity in phages currently used in industry. Isolation and characterization of novel phages increases the options to combat Salmonella in the food and agriculture industries. Local Minnesota wastewater was selected as a source to hunt for these phages because novel phages have been successfully isolated from wastewater in other locations. A total of 27 bacteriophages were successfully isolated from the wastewater samples. Phages were selected based on plaque morphologies that appeared unique when plating enrichment samples on select propagation strain(s) and the ability to withstand the isolation process. Some plaques did not yield stable phages in the conditions used to isolate the phages, so these phages were not assessed further. The 27 successfully isolated phages were enriched and propagated on a variety of Salmonella strains, as summarized in Table 2.2.

TABLE 2.2
Summary of isolated phages, strains used to enrich the phages, and the strains used
for isolation and propagation

| | Enrichment Strains | | Propagation Host Strains | |
|---|---|---|---|---|
| Phage | Strain | Source | Strain | Source |
| EH1 | S. Typhimurium 4/74 | Jay Hinton | S. Typhimurium LT2 SGSC 1412 | SGSC |
| EH2 | S. Typhimurium LT2 SGSC 288- | SGSC | S. Typhimurium LT2 SGSC 1412 | SGSC |
| | waaL mutant | | S. Typhimurium LT2 SGSC 288-waaL | SGSC |
| | | | mutant | |
| EH3 | S. Enteritidis SGSC 2475 | SGSC | S. Typhimurium LT2 SGSC 1412 | SGSC |
| | | | S. Enteritidis SGSC 2475 | SGSC |
| | | | S. Reading E2018018984 | MDH |
| | | | S. Infantis 12018008804-1 | MDH |
| EH4 | S. Typhimurium LT2 SGSC | SGSC | S. Typhimurium LT2 SGSC 1412 | SGSC |
| | 1412 | | | |
| | S. Typhimurium LT2 SGSC 288- | SGSC | S. Typhimurium LT2 SGSC 288-waaL | SGSC |
| | waaL mutant | | mutant | |
| EH5 | S. Typhimurium LT2 SGSC | SGSC | S.. Typhimurium LT2 SGSC 1412 | SGSC |
| | 1412 | | | |
| | S. Typhimurium LT2 SGSC 288- | SGSC | S. Typhimurium LT2 SGSC 288-waaL | SGSC |
| | waaL mutant | | mutant | |
| EH6 | S. Typhimurium 4/74 | Jay Hinton | S. Typhimurium 4/74 | Jay Hinton |
| | S. Kentucky PDX AB7 | PDX | S.. Kentucky PDX AB7 | PDX |
| | S. Montevideo ATCC 8387 | PDX | S. Montevideo ATCC 8387 | PDX |
| EH7 | S. Typhimurium LT2 SGSC | SGSC | S. Typhimurium LT2 SGSC 1412 | SGSC |
| | 1412 | | | |
| EH8 | S. Typhimurium 4/74 | Jay Hinton | S. Typhimurium 4/74 | Jay Hinton |
| EH9 | S. Typhimurium LT2 SGSC | SGSC | S. Typhimurium 4/74 | Jay Hinton |
| | 1412 | | | |
| EH10 | S. Typhimurium LT2 SGSC | SGSC | S. Typhimurium LT2 SGSC 1412 | SGSC |
| | 1412 | | | |
| EH11 | S. Typhimurium LT2 SGSC | SGSC | S. Typhimurium LT2 SGSC 1412 | SGSC |
| | 1412 | | | |
| | S. Enteritidis SGSC 2475 | SGSC | S. Enteritidis SGSC 2475 | SGSC |
| | S. Reading E2018018984 | MDH | S. Reading E2018018984 | MDH |
| | S. Infantis 12018008804-1 | MDH | S. Infantis 12018008804-1 | MDH |
| EH12 | S. Reading E2018018984 | MDH | S. Typhimurium LT2 SGSC 1412 | SGSC |
| | | | S. Enteritidis SGSC 2475 | SGSC |
| | | | S. Reading E2018018984 | MDH |
| | | | S. Infantis 12018008804-1 | MDH |
| EH13 | S. Reading E2018018984 | MDH | S. Typhimurium LT2 SGSC 1412 | SGSC |
| | | | S. Enteritidis SGSC 2475 | SGSC |
| | | | S. Reading E2018018984 | MDH |
| | | | S. Infantis 12018008804-1 | MDH |
| EH14 | S. Infantis 12018008804-1 | MDH | S. Enteritidis SGSC 2475 | SGSC |
| EH15 | S. Typhimurium LT2 SGSC | SGSC | S. Typhimurium LT2 SGSC 1412 | SGSC |
| | 1412 | | | |
| | S. Typhimurium LT2 SGSC 288- | SGSC | S. Typhimurium LT2 SGSC 288-waaL | SGSC |
| | waaL mutant | | mutant | |
| EH16 | S. Typhimurium LT2 SGSC | SGSC | S. Typhimurium LT2 SGSC 1412 | SGSC |
| | 1412 | | S. Typhimurium LT2 SGSC 288-waaL | SGSC |
| | | | mutant | |
| EH17 | S. Typhimurium LT2 SGSC | SGSC | S. Typhimurium LT2 SGSC 1412 | SGSC |
| | 1412 | | S. Typhimurium LT2 SGSC 288-waaL | SGSC |
| | | | mutant | |
| EH18 | S. Typhimurium LT2 SGSC | SGSC | S. Typhimurium LT2 SGSC 1412 | SGSC |
| | 1412 | | S. Typhimurium LT2 SGSC 288-waaL | SGSC |
| | | | mutant | |
| EH19 | S. Typhimurium LT2 SGSC 288 | SGSC | S. Typhimurium LT2 SGSC 1412 | SGSC |
| | | | S. Typhimurium LT2 SGSC 288-waaL | SGSC |
| | | | mutant | |
| EH20 | S. Typhimurium LT2 SGSC 288 | SGSC | S. Typhimurium LT2 SGSC 1412 | SGSC |
| | | | S. Typhimurium LT2 SGSC 288-waaL | SGSC |
| | | | mutant | |
| EH21 | S. Kentucky PDX AB7 | PDX | S. Kentucky PDX AB7 | PDX |
| EH22 | S. Kentucky PDX AB7 | PDX | S. Kentucky PDX AB7 | PDX |
| EH23 | S. Thompson PDX CB3 | PDX | S. Thompson PDX CB 3 | PDX |
| EH24 | S. Thompson PDX CB3 | PDX | S. Thompson PDX CB 3 | PDX |
| EH25 | S. Typhimurium 4/74 | Jay Hinton | S. Typhimurium 4/74 | Jay Hinton |
| | S. Kentucky PDX AB7 | PDX | S.. Kentucky PDX AB7 | PDX |
| | S. Montevideo ATCC 8387 | PDX | S. Montevideo ATCC 8387 | PDX |
| EH26 | S. Typhimurium 4/74 | Jay Hinton | S. Typhimurium 4/74 | Jay Hinton |
| | S. Kentucky PDX AB7 | PDX | S. Kentucky PDX AB7 | PDX |
| | S. Montevideo ATCC 8387 | PDX | S. Montevideo ATCC 8387 | PDX |
| EH27 | S. Typhimurium 4/74 | Jay Hinton | S. Typhimurium 4/74 | Jay Hinton |
| | S. Kentucky PDX AB7 | PDX | S. Kentucky PDX AB7 | PDX |
| | S. Montevideo ATCC 8387 | PDX | S. Montevideo ATCC 8387 | PDX |

Prevalence of different Salmonella serotypes associated with human disease is highly variable with regard to commodity and geography. Determining the phenotypic host range of Salmonella phages provides insight on their individual utility and potential synergy to act against several serotypes when combined into a phage cocktail. Host ranges for the isolated phages were assessed by their ability to create zones of lysis and individual plaques in spot on the lawn assays on several Salmonella strains from serotypes of interest for their roles in human disease or prevalence in food commodities (Table 2.1). Strains characterized as sensitive to a phage had zones of lysis at high phage titers and individual plaques forming at lower titers. Partially sensitive strains were identified by zones of lysis at higher titers but no evidence of individual plaques at reduced titers. Strains resistant to a phage showed no evidence of lysis. The number of Salmonella strains that were either sensitive or partially sensitive was tabulated for each phage (Table 2.3). A greater number of susceptible strains from different serotypes indicates a broader phage host range. The isolated phages' individual abilities to lyse various strains ranged between 32% and 95%. Most phages displayed a unique range of susceptible serotypes, but a few had nearly identical host ranges. This may indicate that these phages are clonal, very closely related, or utilize similar mechanisms of action. The phages EH1, EH7, EH8, and EH9 show similar host ranges to one another. EH1 and EH10, EH3 and EH14, EH16 and EH17, and EH22 and EH24 are pairs of phages that are potentially clonal or closely related. Two trios of phages, EH2, EH19, EH2O and EH6, EH25, and EH26 may also be made of up similar or clonal phages based on the phenotypic host ranges.

TABLE 2.3
Percentage of Salmonella strains sensitive* to isolated phages

| Phage | Salmonella Sensitivity |
|---|---|
| EH1 | 8/19 (42%) |
| EH2 | 13/19 (68%) |
| EH3 | 12/19 (63%) |
| EH4 | 9/19 (47%) |
| EH5 | 14/19 (74%) |
| EH6 | 14/19 (74%) |
| EH7 | 13/19 (68%) |
| EH8 | 13/19 (68%) |
| EH9 | 13/19 (68%) |
| EH10 | 9/19 (47%) |
| EH11 | 13/19 (68%) |
| EH12 | 8/19 (42%) |
| EH13 | 12/19 (63%) |
| EH14 | 9/19 (47%) |
| EH15 | 7/19 (37%) |
| EH16 | 11/19 (58%) |
| EH17 | 11/19 (58%) |
| EH18 | 7/19 (37%) |
| EH19 | 13/19 (68%) |
| EH20 | 13/19 (68%) |
| EH21 | 6/19 (32%) |
| EH22 | 6/19 (32%) |
| EH23 | 10/19 (53%) |
| EH24 | 9/19 (47%) |
| EH25 | 18/19 (95%) |
| EH26 | 12/19 (63%) |
| EH27 | 7/19 (37%) |

*Sensitive defined as presence of zones of lysis and/or plaguing

Concerns over phage resistance are frequently cited as a concern for regular use of phages in biocontrol of foodborne pathogens. Genesis of phage-resistant mutants is considered inevitable due to selective evolutionary pressures in the host. Developing cocktails of phages with unique host ranges may reduce the incidence of resistant mutants arising with phage treatment. Because bacteria have developed numerous mechanisms for phage defense and phages have, in turn, found means to overcome these defenses, a combination of phages with unique host ranges and means of evading host defense systems may act synergistically to overcome defenses raised by resistant mutants. The host ranges of the isolated phages were compared to identify a combination of phages that could lyse most serotypes used in this study. No phage individually had the capability to lyse all strains tested, but six phages were identified that had relatively broad host ranges that complimented each other to encompass all serotypes tested. Additionally, each of these phages lysed a non-pathogenic E. coli K-12 strain. Because of this, one strain of each of the seven serotypes of interest for Shiga-toxin producing E. coli (STEC) were tested for sensitivity to the cocktail phages (Table 2.1). Of the STEC serotypes tested, the phages could all lyse O157:H7, and a few phages could individually lyse O103, O145:NM, and O45:H2. A few Salmonella phages have been identified to capable of lysing STEC strains of the serotype O157:H7, however phages in this study demonstrated the ability to lyse four unique STEC serotypes associated with human disease. In combinations (e.g., of 2, 3, 4, 5 or 6 phages), the six phages identified may work synergistically to combat 17 different serotypes of Salmonella and 4 serotypes of STEC, or 100% and 57% of strains tested in this study.

TABLE 2.4
Table 1. Salmonella and STEC strains sensitive* to phages
individually or in combination

| Phage | Salmonella | STEC |
|---|---|---|
| EH1 | 8/19 (42%) | 2/7 (29%) |
| EH2 | 13/19 (68%) | 2/7 (29%) |
| EH3 | 12/19 (63%) | 2/7 (29%) |
| EH4 | 9/19 (47%) | 2/7 (29%) |
| EH5 | 14/19 (74%) | 2/7 (29%) |
| EH6 | 13/19 (68%) | 4/7 (57%) |
| Cocktail | 19/19 (100%) | 4/7 (57%) |

*Sensitive defined as presence of zones of lysis and/or plaquing

To summarize, local Minnesota wastewater samples were utilized to successfully isolate 27 unique bacteriophages with potential for use to combat Salmonella. Six of these phages were selected for a putative cocktail for food and agriculture applications based on their complimentary host ranges. In combinations, the phages could lyse 19 Salmonella strains representing 17 serotypes. The selected phages were additionally able to lyse four strains of STEC representing 4 serotypes of concern, including O157:H7. Further characterization of these phages will be employed to explore their potential in controlling Salmonella in a food application. Cocktails of these six phages show promise for reducing both major pathogens Salmonella and STEC in food and agriculture applications.

### Example 2. Novel Phage Cocktail Receptor Characterization

Salmonella enterica subsp. enterica is a Gram-negative, rod-shaped bacterium. S. enterica is subdivided into over 2500 groups, known as serotypes, based on variations on the antigenic structures: lipopolysaccharide (LPS), flagella, and for some serotypes the capsular polysaccharide. Of these over 2500 serotypes, only a limited subset is frequently associated with human disease. Salmonella accounts for an estimated 1.35 million illnesses, 26,500 hospitalizations, and 420 deaths annually in the United States, with most of these involving food as the vehicle for the pathogen. Salmonellosis symptoms can manifest anywhere from six hours to twelve days after infection, but these infections are usually self-limiting with symptoms subsiding in ten days or less. Salmonellosis manifests as gastroenteritis, with symptoms commonly involving diarrhea, abdominal pain and cramping, nausea, vomiting, and headache. In some cases, more serious invasive Salmonella infections can occur, most commonly in children under the age of five, the elderly, and the immunocompromised. In rare cases, Salmonella infection can result in long-term effects such as reactive arthritis, which can last for months to years after the infection. Foodborne Salmonella is uniquely associated with a wide range of food sources. Around 75% of outbreaks are attributed to seven categories: chicken, seeded vegetables, pork, fruits, other produce, eggs, and turkey. Moreover, Salmonella prevalence in the food system widely varies with regard to geographic location and commodity.

Common measures employed to control Salmonella in food systems involve chemical antimicrobials, physical, and thermal processing methods. Frequently, high pressure processing, irradiation, and cold atmospheric plasma are utilized for control. However, concerns over these methods have been raised, including environmental impacts of chemical antimicrobials, developing resistance to antimicrobials, and lack of consumer acceptance of irradiated products. Especially important is the concern over these methods impacting the organoleptic properties of the food. Salmonella is attributed with many raw and ready-to-eat foods, such as meat, poultry, and fresh fruits and vegetables, which are not compatible with many of these methods. In recent years, interest in using bacteriophages as a control measure for Salmonella in food applications.

Bacteriophages (phages) are viruses that are specific for bacteria. Phages can undergo different lifecycles, described below, but strictly virulent phages that lyse and kill the host cell are best for use in biocontrol of pathogens in the food industry. Incorporating phages for biocontrol of pathogens in foods and food-contact surfaces is advantageous because phages are highly specific, ubiquitous, naturally found in foods and are unlikely to alter food microflora, and do not alter the organoleptic properties of the foods. Concerns over phages in the food industry are primarily limited efficacy, potential for causing false positive results in pathogen testing, and emergence of phage-resistant mutants.

Phages infect their hosts by first adsorbing to a specific receptor on the cell surface. Nearly any surface structure can serve as a receptor for phages. In Gram-negative bacteria, some presently identified receptors include LPS, other surface polysaccharides, flagella, and proteins such as BtuB, OmpC, OmpA, and TonB. Following this, irreversible binding occurs, and the phage injects its genetic material into the host cell. From this point, phages may either go through the lytic or lysogenic cycles. In the lytic cycle, the phage will seize control of the host's replication system and utilize it to produce new virions. The cycle culminates in the lysis of the host cell to release progeny phage. In contrast phages undergoing the lysogenic cycle incorporate their DNA into the host genome rather than reproducing and lysing the cell. This integrated phage, known as a prophage, may enter the lytic cycle at a later time. Virulent phages are strictly lytic, i.e., they can only go through the lytic cycle. Temperate phages may enter either the lysogenic or lytic cycle, though they more frequently enter the lysogenic cycle. Temperate phages may participate in specialized transduction, a process in which host genes nearby the phage genome are excised with the phage genome as it separates from the host. Specialized transduction can transfer virulence factors or antimicrobial resistance factors into a host's genome that were not found previously. Because of this, phages for use in the food and agriculture sectors should be strictly lytic phages. When selecting lytic phages for a cocktail to control Salmonella, it is beneficial to select phages that recognize different receptors on the Salmonella surface. Changes in surface receptors are the most common cause of phage resistance, so having phages that recognize other receptors on the host allows for continued efficacy of the phage mixture. Commonly recognized Salmonella phage receptors include the LPS, flagella, and porins; however, many Salmonella phages have not yet had their receptors characterized. Identifying receptors for novel phages is important for developing an effective phage cocktail. In this Example, putative receptors for six phages proposed for a novel cocktail for Salmonella control were identified. Additionally, transmission electron micrograph images were generated for taxonomic classification of the phages.

Eight Salmonella strains were utilized for bacteriophage propagation (Table 3.1). Strains used for this study were provided by Paradigm Diagnosic Inc. (PDX), the Salmonella Genetic Stock Centre in Calgary, Alberta, Canada (SGSC), the Minnesota Department of Health (MDH), and Jay Hinton at the University of Liverpool, UK. The strains were cultured at 37° C. for 16-18 hours on Luria-Bertani (LB) broth (Company information) or LB agar plates. For isolating phage-resistant mutants, a gene-knockout mutant library of Salmonella Typhimurium 4/74, created using the Lucigen EZ-Tn5™<KAN-2>Tnp Transposome™ Kit, was stored in LB broth containing 25% v/v glycerol in aliquots representing seven sub libraries. An aliquot of each of the seven sub libraries was thawed on ice directly prior to use. Primers used in this study are listed in Table 2.

TABLE 3.1
Cocktail phages used in this study and their host strain(s)

| | Host(s) | |
|---|---|---|
| Phage | Strain | Source |
| EH1 | S. Typhimurium LT2 SGSC 1412 | SGSC |
| EH2 | S. Typhimurium LT2 SGSC 1412 | SGSC |
| | S. Typhimurium LT2 SGSC 288-waaL mutant | SGSC |
| EH3 | S. Typhimurium LT2 SGSC 1412 | SGSC |
| | S. Enteritidis SGSC 2475 | SGSC |
| | S. Reading E2018018984 | MDH |
| | S. Infantis 12018008804-1 | MDH |
| EH4 | S. Typhimurium LT2 SGSC 1412 | SGSC |
| | S. Typhimurium LT2 SGSC 288-waaL mutant | SGSC |
| EH5 | S. Typhimurium LT2 SGSC 1412 | SGSC |
| | S. Typhimurium LT2 SGSC 288-waaL mutant | SGSC |
| EH6 | S. Typhimurium 4/74 | Jay Hinton |
| | S. Kentucky PDX AB7 | PDX |
| | S. Montevideo ATCC 8387 | PDX |

Phages were propagated using the double agar overlay assay. Briefly, 0.1 mL of phage lysate and 0.1 mL of a culture of propagation strain(s) were mixed in with 4 mL of molten 0.35% w/v LB agar. This mixture was poured onto a 1.5% w/v LB agar plate and allowed to solidify. After incubation at 37° C. for 16-18 hours, the top agar layer was mixed with 6 mL of SM buffer (50 mM Tris-HCl pH7.5, 100 mM NaCl, 8 mM MgSO₄) in a conical tube and centrifuged at 5000 rpm for 15 minutes. The supernatant was filter-sterilized using a 0.22 um pore size syringe filter (Millipore). Filtered phage samples were stored at 4° C.

Phages were plated on the gene-knockout mutant library to identify mutants resistant to the phages due to loss of the phage receptor as a result of EZ-Tn5Tm <KAN-2> insertions. Thawed mutant sub library aliquots and a culture wild-type of Salmonella Typhimurium 4/74 were diluted in LB broth to an approximate concentration of 10⁷ CFU/mL each. Each phage lysate was plated on the individual sub libraries and wild-type 4/74 using the double agar overlay assay. For each phage, five colonies from the sub library with the highest resistance rate compared to wild type were picked and streaked three times for isolation. Colonies were then cultured in LB broth overnight and were tested for true resistance to the phage using a spot on the lawn plaque assay: 0.1 mL of the cultured mutant was combined with 4 mL of 0.35% LB agar. The mixture was poured over an LB agar plate. The associated phage was serially diluted in SM buffer, and 10 uL spots of each dilution were pipetted onto the solidified agar plate. After 16-18 hours of incubation at 37° C., the mutants were checked for signs of lysis. If no lysis was found, the mutant was determined to be resistant to the phage.

Two mutants for each phage were selected to undergo random-primed PCR to amplify the gene in which EZ-Tn5Tm <KAN-2> was inserted to form the mutant. Briefly, colony PCR was performed using three primers with random sequences (APP_A1, APP_A2, APP_A3) expected to bind to various positions and a transposon specific primer that faces outward from Kan2 (Kan2_5A or Kan2_3A). A second PCR reaction was carried out on the products from the first reaction using a primer that anneals to the 5′ end of the product of the random primers (APP_B) and a nested transposon specific primer that anneals to the 3′ end of the product (Kan2_5B or Kan2_3B). Thermocycler conditions for all PCR reactions were as follows:

1. 94° C. for 3 minutes
2. 94° C. for 15 seconds
3. 42° C. for 30 seconds
4. 72° C. for 3 minutes
Repeat steps 2, 3 and 4 five times, increasing
the temperature of step 3 by 1°C per cycle
5. 94° C. for 15 seconds
6. 60° C. for 30 seconds
7. 72° C. for 3 minutes
Repeat steps 5, 6 and 7 24 times
8. 72° C. for 7 minutes

The second PCR products were sent for Sanger sequencing using the nested transposon primer (ACGT Inc., Wheeling, Ill.). Primers used for random-primed PCR are described in Table 3.2. Transposon insertions sites were identified using NCBI BLASTN against Salmonella enterica subsp. enterica serovar Typhimurium str. 4/74 (NCBI taxid:909946; nucleotide accession number NC_016857.1) in the nucleotide collection database.

TABLE 3.2
Primers used for this study

| | | Annealing | Sequence |
|---|---|---|---|
| Primer | Function | Region | (5′ to 3′) |
| APP_A1 | Random | Unknown | GACCA |
| (SEQ ID | Primer | | CACGT |
| NO: 1) | | | CGACT |
| | | | AGTGC |
| | | | NNNNN |
| | | | NNNNN |
| | | | TCTAC |
| APP_A2 | Random | Unknown | GACCA |
| (SEQ ID | Primer | | CACGT |
| NO: 2) | | | CGACT |
| | | | AGTGC |
| | | | NNNNN |
| | | | NNNNN |
| | | | ACGCC |
| APP_A3 | Random | Unknown | GACCA |
| (SEQ ID | Primer | | CACGT |
| NO: 3) | | | CGACT |
| | | | AGTGC |
| | | | NNNNN |
| | | | NNNNN |
| | | | GATAC |
| APP_B | Random | 5′ End | GACCA |
| (SEQ ID | Primer | of | CACGT |
| NO: 4) | Compliment | Random | CGACT |
| | | Primers | AGTGC |
| KAN2_5A | Transposon- | 5′ End | GAATA |
| (SEQ ID | Specific | of Kan2 | TGGCT |
| NO: 5) | Primer | Facing | CATAA |
| | | Out | CACCC |
| | | | CTTGT |
| | | | ATTAC |
| | | | TG |
| KAN2_5B | Transposon- | 3′ | CTTGT |
| (SEQ ID | Specific | End of | GCAAT |
| NO: 6) | Nested | KAN2_5A | GTAAC |
| | Primer | | ATCAG |
| | | | AGATT |
| | | | TTGAG |
| KAN2_3A | Transposon- | 3′ End | CCAAC |
| (SEQ ID | Specific | of Kan2 | TGGTC |
| NO: 7) | Primer | Facing | CACCT |
| | | Out | ACAAC |
| | | | AAAG |
| KAN2_3B | Transposon- | 3′ End of | CAAAG |
| (SEQ ID | Specific | Kan2_3A | CTCTC |
| NO: 8) | Nested | | ATCAA |
| | Primer | | CCGTG |
| | | | GC |

Transmission electron microscopy was used to view the morphology of the phage virions. Filtered lysates of each phage at a titer of approximately 10⁹ PFU/mL each were submitted to the University of Minnesota Imaging Center (Saint Paul, Minn.). The phage samples were prepared and imaged as follows. 10 uL aliquots of phage lysate were placed onto a 200-mesh formvar/carbon-coated copper grid. Remaining samples were wicked away from the grid after 30 seconds using a piece of filter paper. Phages were stained on the grid using 10 uL of 0.5% phosphotungstic acid (pH 7). After two minutes the stain was wicked away using a piece of filter paper. Following this, the grid was air-dried for 5 minutes. Phages were imaged at 60,000× magnification using a JEOL JEM-1400Plus transmission electron microscope at 60 kV. An Advanced Microscopy Techniques XR16 camera was used to record the images of the phages using AMT Capture Engine software ver. 7.0.0.187. Phages were classified using the updated International Committee on Taxonomy of Viruses (ICTV) guidelines.

Identifying receptors of phages intended for use in biocontrol of pathogens helps to identify which phages may work best together due to having different, widely conserved receptors can reduce the incidence of resistance in food settings. Receptor identification gives insights into serotypes that are likely to be susceptible to the phage based on their surface structures, which may allow for specific targeting of serotypes of interest with phages. Incorporating phages known to have different, broadly conserved receptors provides additional means of infection in the case of a mutation developing that restricts a phage from binding to its receptor. Despite the benefits of identifying phage receptors, many have not been characterized. Putative receptors for 6 phages selected for inclusion in a novel phage cocktail for use against Salmonella were identified using gene-knockout mutants that were resistant to the phages due to EZ-Tn5Tm <KAN-2> insertions in genes encoding for the receptor. After PCR amplification and Sanger sequencing, the genes with an EZ-Tn5Tm <KAN-2> insertion. Insertions for phages EH1, EH2, EH3, and EH6 occurred at nucleotide 4370298, which is inside gene btuB. EH4 and EH5 had insertions at 4368990 and 4370599 respectively, which are also located in btuB but indicate independent btuB insertions (Table 3.3). btuB is a gene that encodes for a porin that aids in the diffusion of vitamin B12 into the host cell. The BtuB protein is widely conserved, with Escherichia coli and Salmonella btuB genes showing high similarity. This may account for the ability of all six phages to lyse various E. coli serotypes. BtuB has been identified previously as a receptor for Salmonella phages.

While BtuB is a recognized Salmonella phage receptor, this leaves room for uncertainty over why each of the six phages appears to have a unique host range despite sharing a common receptor. In some cases, phages with multiple receptors have been identified, such as phage SP6 which has two types of receptor binding proteins, which allow it to have a greater host range than a phage with only one identified receptor. T4 and some other phages require more than one receptor for infection. In the case of T4, the porin OmpC and LPS are coreceptors for infection. The phage can successfully infect its host when OmpC is present, but when OmpC is unavailable for the phage it may only infect a host with LPS terminating on a glucose residue. Additionally, receptor identification is not the only factor that determines a phage host range. Other surface structures such as LPS on the cell can influence the ability of a phage to bind to a receptor. Different Salmonella serotypes and strains can vary in their defense mechanisms against the phage, some of which are activated after phages have bound to the receptor. Some phages have mechanisms of avoiding these host defenses, making them effective while others with the same receptor may be rendered useless. Even differences in transcriptional and translational processes in the host can determine the ability of a phage to successfully replicate and lyse the cell. Further investigation into other host range determinants will be useful into providing greater insight into the variation in host ranges between these phages.

TABLE 3.3
BLASTN Identified EZ-Tn5 ™ <KAN-2> Insertion Sites in Salmonella enterica
subsp. enterica serovar Typhimurium str. 4/74 Genome and Putative Phage Receptors. Genome
NCBI taxid:909946 and nucleotide accession number NC_016857.1.

| | Nucleotide Insertion | | Gene Position | Gene Accession | Putative |
|---|---|---|---|---|---|
| Phage | Point | Gene | in Genome | Number | Receptor |
| EH1 | 4370298 | btuB | 4369549 to | CP002487 | BtuB |
| EH2 | 4370298 | | 4371393 | | |
| EH3 | 4370298 | | | | |
| EH4 | 4368990 | | | | |
| EH5 | 4370599 | | | | |
| EH6 | 4370298 | | | | |

Images returned of the six phages showed that all six are tailed phages with polyhedral capsids. Phages EH1, EH2, EH3, and EH4 appear to have a long, flexible tail. No contractile sheath is visible in the images of this phage. Phage EH5 displays a long, rigid tail which appears to be contractile. Phage EH6 also has a relatively long tail with a contractile sheath. In contrast to EH5, EH6 has small “star-like” appendages extending from the base of the tail. The other five phages are likely to have thin tail fibers near the base of the tail, but these are not readily visible in the TEM images. The 2018 ICTV guidelines group tailed phages into the Caudovirales order. Phages with a long, flexible tail that is not contractile belong to the Siphoviridae family. The Myoviridae family consists of phages with a long, inflexible tail that is contractile. The newly recognized family of Ackermannviridae have a morphology similar to Myoviridae, but they have a unique binding structure that consists of short structures with bulbous tips at the base of the tail. Based on these classification guidelines, EH1, EH2, EH3, and EH4 can be presumed to belong to the family Siphoviridae, EH5 belongs to the Myoviridae family, and EH6 likely belongs to the Ackermannviridae family, as summarized in Table 3.4.

TABLE 3.4
Taxonomic classification of phages

| Phage | Order | Family | Defining Characteristics |
|---|---|---|---|
| EH1 | Caudovirales | Siphoviridae | Long, flexible, non-contractile |
| | | | tail |
| EH2 | Caudovirales | Siphoviridae | Long, flexible, non-contractile |
| | | | tail |
| EH3 | Caudovirales | Siphoviridae | Long, flexible, non-contractile |
| | | | tail |
| EH4 | Caudovirales | Siphoviridae | Long, flexible, non-contractile |
| | | | tail |
| EH5 | Caudovirales | Myoviridae | Long, sheathed, contractile tail |
| EH6 | Caudovirales | Ackermannviridae | Long, sheathed, contractile tail; |
| | | | short, filamentous adsorption |
| | | | structure a tbaseplate |

To summarize, a greater understanding of the mechanism of action for a bacteriophage is important for successfully designing a phage cocktail for biocontrol of Salmonella. An optimal phage cocktail contains several phages with unique, broad host ranges and multiple receptors to reduce the incidence of resistant Salmonella. In this study, six phages for a novel cocktail were TEM imaged to determine their taxonomy, and putative receptors were determined for the phages. All six phages were found to belong to the order Caudovirales, with four of the family Siphoviridae, one in the family of Myoviridae, and one belonging to Ackermannviridae. BtuB, a gene encoding for a B12 importing porin, was determined to be a putative receptor for all six phages. This leaves some uncertainty about the reason for each phage having a unique host range. Further analysis to explore additional receptors or means of evading the hosts' intracellular defense mechanisms can provide more insight into the phages' efficacy on various serotypes and potential to suppress resistance.

### Example 3. Reduction of Salmonella by Phage Cocktail in a Raw Chicken Breast Model

Salmonella enterica subsp. enterica is a Gram-negative, rod-shaped bacterium which is known as the causative agent of salmonellosis. In the United States alone, approximately 1.35 million infections, 26,500 hospitalizations, and 420 deaths are attributed to Salmonella every year. The majority of these cases involve food as the vehicle for transmission. Salmonellosis is characterized by gastroenteritis, accompanied symptoms often include diarrhea, nausea, vomiting, abdominal pain and cramping, and headache. These symptoms may begin anywhere from six hours to twelve days after infection, and in most cases the symptoms will subside in ten days or fewer. In some severe cases, invasive Salmonella infections may occur; those under the age of five, the elderly, and the immunocompromised are most at risk. In other cases, long term effects such as reactive arthritis can remain for months to years after infection. Preliminary reporting by Foodborne Diseases Active Surveillance Network for the year 2019 indicated that rates of Salmonella infections attributed to food sources did not decrease overall compared to the previous three years.

A wide range of foods are attributed to Salmonella outbreaks. Nearly 75% of Salmonella outbreaks are associated with seven food categories: chicken, seeded vegetables, pork, fruits, other produce, eggs, and turkey, and each food is frequently associated with a particular serotype of Salmonella. S. enterica is subdivided into over 2500 groups known as serotypes. Serotypes are based on variations in the antigenic structures on the cell surfaces, which are lipopolysaccharide (LPS) and flagella, and, in a couple serotypes, capsular polysaccharide. Prevalence of Salmonella serotypes vary with geographic region and commodity. In poultry, Salmonella serotype Enteritidis is most common in Asia, Latin America, Europe, and Africa. In North America and Oceania, serotypes Kentucky, Typhimurium, and Sofia are the most prevalent serotypes. While Kentucky is not yet known to have caused any outbreaks, it is important to closely monitor this serotype because of its prevalence.

Since 2015, at least nine outbreaks of Salmonella attributed to poultry have been reported. In 2021, at least two outbreaks of Salmonella attributed to poultry have occurred, one from ground turkey and the other from raw frozen breaded stuffed chicken products. Chickens are highly susceptible to gut colonization from Salmonella due to a wide variety of factors, including stress and rearing conditions, feed additives containing antimicrobials, transmission at hatching from infected parent, among others. With chicken consumption increasing from 22.4 pounds to 52.3 pounds per capita between 1970 and 2017, controlling Salmonella in chicken is very important.

Because of the complex and diverse nature of food matrices, phage efficacy varies with the type of food they are applied to. Parameters that affect phage efficacy in food matrices include pH, sodium levels, temperature, physical topology, and others. Concerns have been cited over varying phage efficacy in meat matrices. For example, a study involving a phage targeting Listeria monocytogenes found that reductions of the pathogen varied between roast beef and turkey meat slices, despite treatments being otherwise identical, suggesting that phages may be immobilized on the meat surface to varying degrees based on the meat type. Phages rely on diffusion to reach their hosts, so immobilization on a solid, complex matrix like poultry could reduce efficacy of phages for biocontrol in these products. While this could be minimized by using a higher concentration of phages to increase the odds of reaching a target cell, it may be possible that using an added surfactant could help phage mobility across the surface.

The efficacy of phages can also be increased or hindered by additives to the food. Some disinfectants, such as ethanol and peracetic acid, used in the food processing environment can inactivate phages. Accordingly, these additives may be excluded from use with the phage cocktails described herein. In contrast, several food additives in combination with phages have helped to achieve greater reductions in pathogen numbers. Accordingly, these additives may be included with the use of the phage cocktails described herein. In particular, levulinic acid, nisin, potassium sorbate, potassium lactate, and sodium diacetate are reported to work well in combination with phages in food applications. Lauric arginate, a cationic surfactant, has also proven effective in working synergistically with Salmonella phages to reduce the pathogen levels in chicken products. Lauric arginate is known for antimicrobial activity as a food additive, but it is possible that its surfactant properties aided the phage mobility. In this study, a six-phage cocktail was applied to chicken samples inoculated with Salmonella Typhimurium to assess the phage efficacy in a food challenge model. Additionally, of 0.1% w/v Tween 80, also known as polysorbate 80—a GRAS food additive known to be a nonionic surfactant, was applied in combination with the phage cocktail to determine if this would further reduce Salmonella levels in the chicken samples by increasing the phages' motility, helping the phages to encounter a host.

The challenge strain used in this study, S. Typhimurium 4/74, and each host strain used for phage propagation and enumeration were cultured at 37° C. for 16-18 hours on Luria-Bertani (LB) broth or LB agar plates.

Phages were propagated the double agar overlay assay. Briefly, 0.1 mL of phage lysate and 0.1 mL of a culture of propagation strain(s) were mixed in with 4 mL of molten 0.35% w/v LB agar. This mixture was poured onto a 1.5% w/v LB agar plate and allowed to solidify. After incubation at 37° C. for 16-18 hours, the top agar layer was mixed with 6 mL of SM buffer (50 mM Tris-HCl pH7.5, 100 mM NaCl, 8 mM MgSO₄) in a conical tube and centrifuged at 5000 rpm for 15 minutes. The supernatant was filter-sterilized through a 0.22 um pore size syringe filter (Millipore). Phage titers were measured by serially diluting the lysates, plating each dilution in a double agar overlay on their host strain(s), and incubation for 16-18 hours overnight to determine the number of plaque-forming units (PFU) per mL. To prepare the phage cocktail, each phage was diluted in phosphate buffered saline (137 mM NaCl, 2.7 mM KCl, 10 mM Na₂HPO₄, 1.8 mM KH₂PO₄) to 10⁹ PFU/mL if necessary. One milliliter aliquots of each phage at 10⁹ PFU/mL were combined into a conical tube, and the cocktail was stored at 4° C. until use.

TABLE 4.1
Challenge strain and phages used in this study
Challenge strain
S. Typhimurium 4/74

| | Host(s) | |
|---|---|---|
| Phage | Strain | Source |
| EH1 | S. Typhimurium LT2 SGSC 1412 | SGSC |
| EH2 | S. Typhimurium LT2 SGSC 1412 | SGSC |
| | S. Typhimurium LT2 SGSC 288- | SGSC |
| | waaL mutant | |
| EH3 | S. Typhimurium LT2 SGSC 1412 | SGSC |
| | S. Enteritidis SGSC 2475 | SGSC |
| | S. Reading E2018018984 | MDH |
| | S. Infantis 12018008804-1 | MDH |
| EH4 | S. Typhimurium LT2 SGSC 1412 | SGSC |
| | S. Typhimurium LT2 SGSC 288- | SGSC |
| | waaL mutant | |
| EH5 | S. Typhimurium LT2 SGSC 1412 | SGSC |
| | S. Typhimurium LT2 SGSC 288- | SGSC |
| | waaL mutant | |
| EH6 | S. Typhimurium 4/74 | Jay Hinton |
| | S. Kentucky PDX AB7 | PDX |
| | S. Montevideo ATCC 8387 | PDX |

Frozen, raw chicken breasts were purchased from a local supermarket and stored at −20° C. until use. Chicken breasts were thawed for 48 hours at 4° C., then aseptically sliced into 25 (±0.5) gram pieces. Chicken samples were placed into individual stomacher bags with filters (Nasco Whirl-Pak) and transferred into a biosafety cabinet. Chicken samples were inoculated by pipetting 0.1 mL of a culture of S. Typhimurium 4/74 diluted in PBS to achieve an inoculation level of 10⁵ CFU/g. Sterile spreaders were used to distribute cells evenly across the chicken surface, then samples were dried for 15 minutes at room temperature in the biosafety cabinet. Non-inoculated chicken samples were included as a negative control. Inoculated samples received 0.1 mL of phage cocktail to achieve a multiplicity of infection (MOI) of 100, 0.1% w/w Tween 80 alone, or both 0.1 mL of phage cocktail and 0.1% w/w Tween 80, or PBS for the no treatment group. Each treatment was spread with sterile spreaders to distribute across the sample surface, and samples were dried for 15 minutes after treatment application. The samples were sealed and stored for 14 days at 4° C. Cell counts were performed after 14 days of incubation by adding 225 mL of PBS to each stomacher bag and homogenizing samples in a stomacher for 60 seconds each. Each sample was plated in triplicate by spreading 0.1 mL on XLT4 agar plates. Plates were incubated for 24 hours at 37° C. prior to enumeration of cells.

Unpaired, one-tailed T-tests were performed in Excel to determine if any of the treatment groups—0.1% w/w Tween 80, the phage cocktail, or both 0.1% w/w Tween 80 and the cocktail combined—had significantly different Salmonella levels from the no treatment group. A p-value less than 0.05 was considered statistically significant.

An unpaired, two-tailed T test was performed in Excel to determine if there was a significant difference in Salmonella levels between the phage cocktail treatment and the phage cocktail plus 0.1% w/w Tween 80 treatment.

The phage cocktail alone reduced the level of Salmonella on the chicken breast samples significantly (p<0.05), a nearly 0.7 log reduction. This is similar to results seen in other Salmonella phage studies in food models where reductions have ranged from 0.4 log to 3 logs were reported. The MOI used in this study was approximately 100 phages per every 1 Salmonella cell, or an MOI of 100. MOI is an important determinant of phage efficacy because a greater density of phage particles in a given area or volume compared to host cells increases the chances that a phage will encounter a host. Approximately 10⁷ PFU/g was applied to the chicken, although some recommendations state that no fewer than 10⁸ PFU/g should be used. Thus, increasing the MOI and phage density may result in greater reductions of Salmonella by this cocktail. Additionally, the food matrix dictates the efficacy of the phages in part, meaning that this cocktail may prove more or less effective for other food products. It can be concluded, though, that the cocktail has the capacity to supplement other measures for reducing Salmonella in poultry and other products.

The addition of 0.1% w/w Tween 80 to the chicken did also significantly reduce the Salmonella levels when applied in combination with the phage cocktail. No reduction was seen with the addition of 0.1% w/w Tween 80 alone, indicating that it did not have an antimicrobial effect. The phage cocktail with the addition of the surfactant yielded a nearly 0.5 log reduction, which is roughly 15% less than the phage cocktail alone.

The difference in the remaining Salmonella counts using phage alone versus phage with the addition of the surfactant was statistically significant. It appears that while a fair reduction occurred in the presence of 0.1% w/w Tween 80 with the phage cocktail, the surfactant may have hindered the phage rather than aiding its mobility. Because phages are charged, with the heads usually possessing a negative charge and the tails possessing a positive charge, 0.1% w/w Tween 80 was selected due to its nonionic nature, in addition to being GRAS. The aim of this was to avoid major interactions between the phage and a charged surfactant, and nonionic surfactants have proved helpful in using phages to control biofilms in healthcare settings. However, a study evaluating the impacts on nonionic, ionic, and biological surfactants on phage survival and ability to adsorb to sorbents found that surfactants reduced phage survival and prevented phages from adsorbing by either displacing the phages or by occupying available positions on the sorbent. Interestingly, the authors conclude that reduction in sorption may allow for greater phage mobility and that nonionic surfactants are less likely to harm phages than ionic surfactants. The interactions between surfactants, proteins, lipid membranes, and structures is incredibly complex (Heerklotz, 2008; Otzen, 2011), leaving many questions about the interactions between Tween 80, phages, and the molecular structures involved in this model that are beyond the scope of this study. Overall, it seems that there may be a detrimental effect of Tween 80 on phages, and this may be a necessary consideration when deciding product formulation if phages are going to be added. As such, in certain embodiments, surfactants such as Tween 80 are optionally used with the cocktails described herein. In certain embodiments, surfactants such as Tween 80 are not used with the cocktails described herein.

TABLE 4.2
Mean S. Typhimurium strain 4/74 cells recovered from chicken
pieces after 14 days

| | CPU per 25 g | Log CFU per |
|---|---|---|
| Treatment | (±SD*) | 25 g (±SD*) |
| No Treatment | 8.89 · 10⁵ (±2.43 · 10⁴) | 5.94 (±0.12) |
| 0.1% Tween 80 Only | 1.02 · 10⁶ (±4.48 · 10⁴) | 5.97 (±0.17) |
| Phages + 0.1% Tween 80 | 3.09 · 10⁵ (±4.80 · 10⁵) | 5.49 (±0.07) |
| Phages Only | 1.90 · 10⁵ (±2.35 · 10⁵) | 5.28 (±0.05) |

*SD-standard deviation. Means were calculated from 3 biological replicates with 3 technical replicates for each condition.

TABLE 4.3
Reduction in S. Typhimurium strain 4/74 cell recovery for each treatment
group compared to the no treatment group (p < 0.05, n = 3).

| | Log | % | Significantly |
|---|---|---|---|
| Condition | Reduction | Reduction | Different |
| 0.1% Tween 80 Only | −0.06 | −15% | No |
| Phages + 0.1% Tween 80 | 0.46 | 65% | Yes |
| Phages Only | 0.67 | 79% | Yes |

Chicken and other poultry remain major vehicles for Salmonella outbreaks. Bacteriophage cocktails have been proposed for biocontrol of Salmonella in food systems, including in raw turkey. This proposed phage cocktail significantly decreased the level of S. Typhimurium 4/74 in chicken breasts by nearly 0.7 log when applied at an approximate MOI of 100. The surfactant Tween 80 did not act synergistically with the phage cocktail to reduce Salmonella levels in the chicken but rather appeared to have an antagonistic effect. This may be necessary to take into consideration when applying phage cocktails for biocontrol in products formulated with Tween 80. Overall, this putative phage cocktail shows promise for reducing Salmonella in food products. It may be particularly useful in a hurdle approach i.e., in combination with other food preservation methods. Further testing on other food matrices will give a more comprehensive view of the abilities of this cocktail as a biocontrol agent.

Sequencing work is being completed for the phages described herein.

Incorporated by reference herein in its entirety is “Isolation and Characterization of Bacteriophages for Bicontrol of Salmonella and Shiga Toxin-Producing Escherichia coli in Food Applications”, a Thesis submitted to the faculty of the University of Minnesota by Eleanore G Hansen, 2021 (hdl.handle.net/11299/224922).

All documents cited herein are incorporated by reference. While certain embodiments of invention are described, and many details have been set forth for purposes of illustration, certain of the details can be varied without departing from the basic principles of the invention.

The use of the terms “a” and “an” and “the” and similar terms in the context of describing embodiments of invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. In addition to the order detailed herein, the methods described herein can be performed in any suitable order unless otherwise indicated herein or otherwise clearly contradicted by context. The use of any and all examples, or exemplary language (e.g., “such as”) provided herein, is intended merely to better illuminate embodiments of invention and does not necessarily impose a limitation on the scope of the invention unless otherwise specifically recited in the claims. No language in the specification should be construed as indicating that any non-claimed element is essential to the practice of the invention.

What is claimed is:

1. A composition comprising a combination of at least two bacteriophages selected from bacteriophages EH1, EH2, EH3, EH4, EH5, EH6, EH7, EH8, EH9, EH10, EH11, EH12, EH13, EH14, EH15, EH16, EH17, EH18, EH19, EH2O, EH21, EH22, EH23, EH24, EH25, EH26 and EH27.

2. The composition of claim 1, where in the composition comprises at least three bacteriophages selected from bacteriophages EH1, EH2, EH3, EH4, EH5, EH6, EH7, EH8, EH9, EH10, EH11, EH12, EH13, EH14, EH15, EH16, EH17, EH18, EH19, EH2O, EH21, EH22, EH23, EH24, EH25, EH26 and EH27.

3. The composition of claim 1, wherein the bacteriophages are selected from EH1, EH2, EH3, EH4, EH5 and EH6.

4. The composition of claim 3, which comprises bacteriophage EH6.

5. The composition of claim 3, which comprises bacteriophage EH5.

6. The composition of claim 3, which comprises bacteriophage EH2.

7. The composition of claim 3, which comprises bacteriophage EH3.

8. The composition of claim 3, which comprises bacteriophages EH5 and EH6.

9. The composition of claim 8, which comprises bacteriophages EH2 or EH3 and EH5 and EH6.

10. The composition of claim 9, which comprises bacteriophages EH2, EH5 and EH6.

11. The composition of claim 9, which comprises bacteriophages EH3, EH5 and EH6.

12. A method for reducing the presence of Salmonella enterica and/or Escherichia coli comprising contacting the Salmonella enterica and/or Escherichia coli with an effective amount of the composition of claim 1.

13. The method of claim 12, wherein the method reduced the presence of Salmonella enterica.

14. The method of claim 12, wherein the method reduced the presence of Escherichia coli.

15. The method of claim 12, wherein the method reduces the presence of Salmonella enterica and Escherichia coli.

16. The method of claim 12, wherein the Escherichia coli is Escherichia coli O157:H7.

17. The method of claim 12, wherein Salmonella enterica and/or Escherichia coli is on a surface.

18. The method of claim 17, wherein the surface is the surface of chicken, vegetable, fruit, egg, turkey or beef.

19. The method of claim 17, wherein the surface is a food-contact surface.

20. The method of claim 12, wherein the method does not comprise contacting the surface with a surfactant.
